(19) United States
(12) Patent Application Publication
(10) Pub. No.: US 2022/0222581 A1
(43) Pub. Date: Jul. 14, 2022

(54) CREATION METHOD, STORAGE MEDIUM, AND INFORMATION PROCESSING APPARATUS

(71) Applicant: FUJITSU LIMITED, Kawasaki-shi (JP)

(72) Inventor: Yoshihiro OKAWA, Yokohama (JP)

(73) Assignee: FUJITSU LIMITED, Kawasaki-shi, Kanagawa (JP)

(21) Appl. No.: 17/708,063

(22) Filed: Mar. 30, 2022

Related U.S. Application Data
(63) Continuation of application No. PCT/JP2019/041574, filed on Oct. 23, 2019.

(51) Int. Cl. G06N 20/00; G06K 9/62

(52) U.S. Cl. CPC G06N 20/00; G06K 9/628; G06K 9/6256; G06K 9/623

(57) ABSTRACT

A creation method for a computer to execute a process includes training a first detection model by using a first training data set; acquiring each of scores of a plurality of pieces of training data included in the first training data set by using the first detection model; creating a second training data set by excluding a part of the training data from the first training data set based on the scores; and training a second detection model by using the second training data set.

### CROSS-REFERENCE TO RELATED APPLICATION

This application is a continuation application of International Application PCT/JP2019/041574 filed on Oct. 23, 2019 and designated the U.S., the entire contents of which are incorporated herein by reference.

### FIELD

The embodiments discussed herein are related to a creation method, a storage medium, and an information processing apparatus.

### BACKGROUND

In recent years, machine learning models having a data determination function, a classification function, and the like have been introduced into information systems used by companies and the like. Hereinafter, the information system will be described as a “system”. Since the machine learning model performs determination and classification according to teacher data that the machine learning model is trained with at the time of system development, the accuracy of the machine learning model deteriorates if the tendency of input data changes during the system operation.

FIG. 27 is a diagram for explaining the deterioration of the machine learning model due to a change in the tendency of the input data. It is assumed that the machine learning model described here is a model that classifies the input data into one of a first class, a second class, and a third class, and is pre-trained based on the teacher data before system operation. The teacher data includes training data and validation data.

In FIG. 27, a distribution 1A illustrates a distribution of input data at an initial stage of system operation. A distribution 1B illustrates a distribution of input data at a time point when T1 hours have passed since the initial stage of the system operation. A distribution 1C illustrates the distribution of input data at a time point when T2 hours have further passed since the initial stage of the system operation. It is assumed that the tendency (feature amount or the like) of the input data changes with passage of time. For example, if the input data is an image, the tendency of the input data changes depending on the season and the time zone even if the image is captured of the same subject.

A determination boundary 3 indicates a boundary between model application regions 3a to 3c. For example, the model application region 3a is a region where training data belonging to the first class is distributed. The model application region 3b is a region where training data belonging to the second class is distributed. The model application region 3c is a region where training data belonging to the third class is distributed.

A star mark is input data belonging to the first class, and it is correct that this input data is classified into the model application region 3a when input to the machine learning model. A triangle mark is input data belonging to the second class, and it is correct that this input data is classified into the model application region 3b when input to the machine learning model. A circle mark is input data belonging to the third class, and it is correct that this input data is classified into the model application region 3a when input to the machine learning model.

In the distribution 1A, all pieces of input data are distributed in a normal model application region. For example, the input data of the star mark is located in the model application region 3a, the input data of the triangle mark is located in the model application region 3b, and the input data of the circle mark is located in the model application region 3c.

In the distribution 1B, since the tendency of the input data has changed, all the pieces of the input data are distributed in the normal model application region, but the distribution of the input data of the star marks changes in the direction of the model application region 3b.

In the distribution 1C, the tendency of the input data further changes, part of the input data of the star marks moves across the determination boundary 3 to the model application region 3b and is not properly classified, and the correct answer rate decreases (accuracy of the machine learning model is degraded).

Here, as a technique for detecting an accuracy deterioration of the machine learning model in operation, there is a conventional technique using T² statistic (Hotelling's T-square). In this conventional technique, the input data and the data group of the normal data (training data) are analyzed by main component analysis, and the T² statistic of the input data is calculated. The T² statistic is the sum of squares of distances from the origin of each standardized main component to the data. The conventional technique detects the accuracy deterioration of the machine learning model based on a change in the distribution of the T² statistic of the input data group. For example, the T² statistic of the input data group corresponds to the ratio of abnormal value data.

A. Shabbak and H. Midi, “An Improvement of the Hotelling T² Statistic in Monitoring Multivariate Quality Characteristics”, Mathematical Problems in Engineering (2012) 1-15 is disclosed as related art.

### SUMMARY

According to an aspect of the embodiments, a creation method for a computer to execute a process includes training a first detection model by using a first training data set; acquiring each of scores of a plurality of pieces of training data included in the first training data set by using the first detection model; creating a second training data set by excluding a part of the training data from the first training data set based on the scores; and training a second detection model by using the second training data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a reference technique;

FIG. 2 is a diagram for explaining a mechanism for detecting an accuracy deterioration of a machine learning model to be monitored;

FIG. 3 is a diagram (1) illustrating an example of a model application region by the reference technique;

FIG. 4 is a diagram (2) illustrating an example of the model application region by the reference technique;

FIG. 5 is a diagram (1) for explaining the processing of an information processing apparatus according to the present embodiment;

FIG. 6 is a diagram (2) for explaining the processing of the information processing apparatus according to the present embodiment;

FIG. 7 is a diagram for explaining effects of the information processing apparatus according to the present embodiment;

FIG. 8 is a functional block diagram illustrating a configuration of the information processing apparatus according to the present embodiment;

FIG. 9 is a diagram illustrating an example of a data structure of a training data set;

FIG. 10 is a diagram for explaining an example of the machine learning model;

FIG. 11 is a diagram illustrating an example of a data structure of an inspector table;

FIG. 12 is a diagram illustrating an example of a data structure of a training data table;

FIG. 13 is a diagram illustrating an example of a data structure of an operation data table;

FIG. 14 is a diagram illustrating an example of a classification surface of an inspector M0;

FIG. 15 is a diagram comparing classification surfaces of inspectors M0 and M2;

FIG. 16 is a diagram illustrating the classification surface of each inspector;

FIG. 17 is a diagram illustrating an example of a classification surface in which the classification surfaces of all the inspectors are overlapped;

FIG. 18A and FIG. 18B are diagrams illustrating an example of a data structure of an output result table;

FIG. 19 is a diagram illustrating an example of a data structure of output results of the output result table;

FIG. 20 is a diagram (1) for explaining processing of a detection unit;

FIG. 21 is a diagram illustrating changes in an operation data set with passage of time;

FIG. 22 is a diagram (2) for explaining the processing of the detection unit;

FIG. 23 is a diagram illustrating an example of a graph of accuracy deterioration information;

FIG. 24 is a flowchart (1) illustrating a processing procedure of the information processing apparatus according to the present embodiment;

FIG. 25 is a flowchart (2) illustrating a processing procedure of the information processing apparatus according to the present embodiment;

FIG. 26 is a diagram illustrating an example of a hardware configuration of a computer that implements functions similar to the information processing apparatus according to the present embodiment; and

FIG. 27 is a diagram for explaining a deterioration of a machine learning model due to a change in tendency of the input data.

### DESCRIPTION OF EMBODIMENTS

In the above-mentioned conventional technique, it is difficult to apply the T² statistic to high-dimensional data such as image data, and it is not possible to detect the accuracy deterioration of the machine learning model.

For example, in high-dimensional (thousands to tens of thousands of dimensions) data that originally has a very large amount of information, most of the information is lost when the dimensions are reduced by main component analysis. Thus, important information (feature amount) for performing classification and determination is lost, and it is not possible to detect abnormal data well and to detect the accuracy deterioration of the machine learning model.

In one aspect, it is an object of the present embodiments to provide a creation method, a creation program, and an information processing apparatus capable of detecting the accuracy deterioration of the machine learning model.

Hereinafter, embodiments of a creation method, a creation program, and an information processing apparatus disclosed in the present application will be described in detail with reference to the drawings. Note that the embodiments do not limit the present invention.

### EMBODIMENT

Before explaining the present embodiment, a reference technique for detecting accuracy deterioration of a machine learning model will be described. In the reference technique, the accuracy deterioration of the machine learning model is detected by using a plurality of monitors in which the model application region is narrowed under different conditions. In the following description, the monitors will be described as “inspectors”.

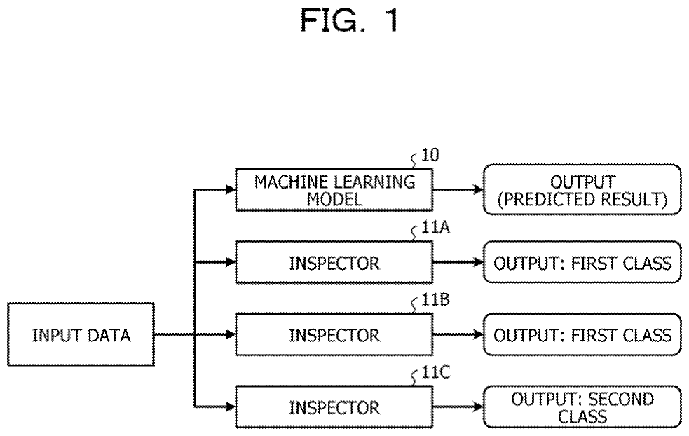

FIG. 1 is a diagram for explaining a reference technique. The machine learning model 10 is a machine learning model that has been machine-learned using teacher data. In the reference technique, the accuracy deterioration of the machine learning model 10 is detected. For example, the teacher data includes training data and validation data. The training data is used when parameters of the machine learning model 10 are machine-learned, and a correct answer label is associated with the training data. The validation data is data used when verifying the machine learning model 10.

The inspectors 11A, 11B, and 11C have model application regions narrowed respectively under different conditions and have different determination boundaries. Since the inspectors 11A to 11C have respective different determination boundaries, output results may differ even if the same input data is input. In the reference technique, the accuracy deterioration of the machine learning model 10 is detected based on the difference in the output results of the inspectors 11A to 11C. In the example illustrated in FIG. 1, the inspectors 11A to 11C are illustrated, but accuracy deterioration may also be detected by using another inspector. Deep neural network (DNN) is used for the models of the inspectors 11A to 11C.

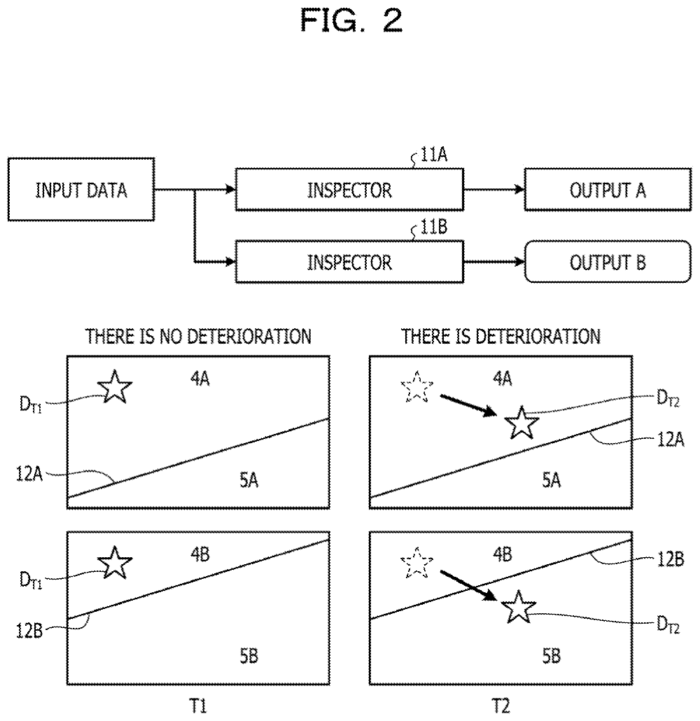

FIG. 2 is a diagram for explaining a mechanism for detecting the accuracy deterioration of the machine learning model to be monitored. In FIG. 2, the inspectors 11A and 11B will be used for explanation. A determination boundary of the inspector 11A is assumed as a determination boundary 12A, and a determination boundary of the inspector 11B is assumed as a determination boundary 12B. The positions of the determination boundary 12A and the determination boundary 12B are different from each other, and the model application region is different.

When input data is located in a model application region 4A, the input data is classified by the inspector 11A into the first class. When the input data is located in a model application region 5A, the input data is classified by the inspector 11A into the second class.

When the input data is located in the model application region 4B, the input data is classified by the inspector 11B into the first class. When the input data is located in the model application region 5B, the input data is classified by the inspector 11B into the second class.

For example, if input data D_{T1} is input to the inspector 11A at time T1 in the initial stage of operation, the input data D_{T1} is located in the model application region 4A and is therefore classified as the “first class”. When the input data D_{T1} is input to the inspector 11B, the input data D_{T1} is located in the model application region 4B and is therefore classified as the “first class”. Since the classification result when the input data D_{T1} is input is the same for the inspector 11A and the inspector 11B, it is determined that “there is no deterioration”.

At time T2 when time has passed since the initial stage of operation, the input data changes in tendency and becomes input data D_{T2}. When the input data D_{T2} is input to the inspector 11A, the input data D_{T2} is located in the model application region 4A and is therefore classified as the “first class”. On the other hand, when the input data D_{T2} is input to the inspector 11B, the input data D_{T2} is located in the model application region 4B and is therefore classified as the “second class”. Since the classification result when the input data D_{T2} is input differs between the inspector 11A and the inspector 11B, it is determined that “there is deterioration”.

Here, in the reference technique, when creating an inspector in which the model application region is narrowed under different conditions, the number of pieces of training data is reduced. For example, the reference technique randomly reduces the training data for each inspector. Furthermore, in the reference technique, the number of pieces of training data to be reduced is changed for each inspector.

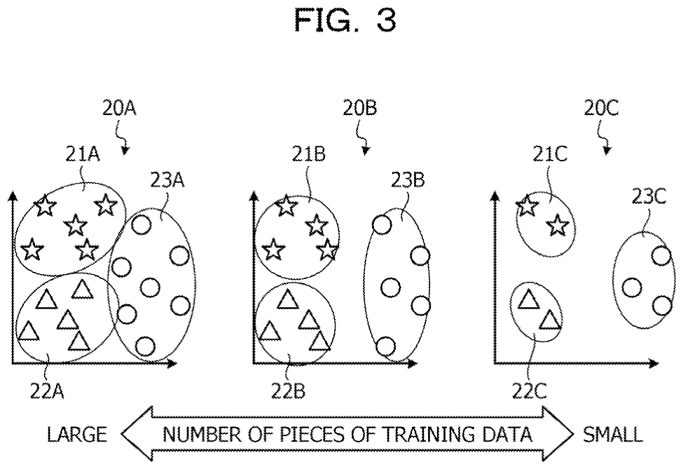

FIG. 3 is a diagram (1) illustrating an example of the model application region by the reference technique. In the example illustrated in FIG. 3, distributions 20A, 20B, and 20C of the training data are illustrated. The distribution 20A is a distribution of training data used when creating the inspector 11A. The distribution 20B is a distribution of training data used when creating the inspector 11B. The distribution 20C is a distribution of training data used when creating the inspector 11C.

A star mark is training data whose correct answer label is the first class. A triangle mark is training data whose correct answer label is the second class. A circle mark is training data whose correct answer label is the third class.

The number of pieces of training data used when creating each inspector is in the order of the inspector 11A, the inspector 11B, and the inspector 11C in descending order.

In the distribution 20A, the model application region of the first class is a model application region 21A. The model application region of the second class is a model application region 22A. The model application region of the third class is a model application region 23A.

In the distribution 20B, the model application region of the first class is a model application region 21B. The model application region of the second class is a model application region 22B. The model application region of the third class is a model application region 23B.

In the distribution 20C, the model application region of the first class is a model application region 21C. The model application region of the second class is a model application region 22C. The model application region of the third class is a model application region 23C.

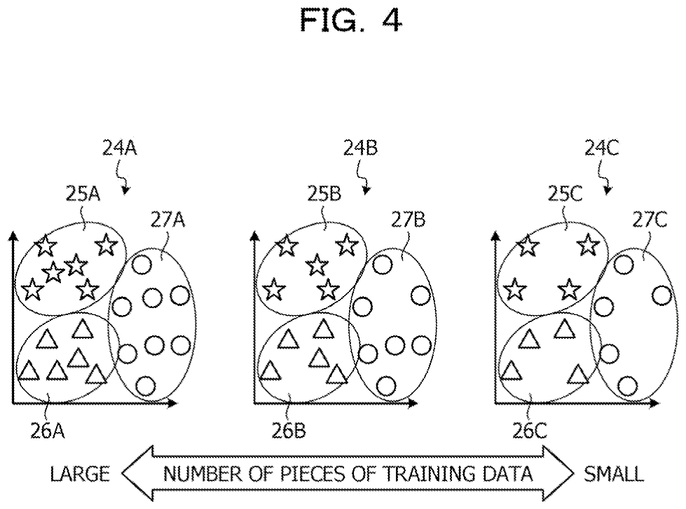

However, even if the number of pieces of training data is reduced, the model application region may not necessarily be narrowed as described in FIG. 3. FIG. 4 is a diagram (2) illustrating an example of the model application region by the reference technique. In the example illustrated in FIG. 4, distributions 24A, 24B, and 24C of the training data are illustrated. The distribution 24A is a distribution of training data used when creating the inspector 11A. The distribution 24B is a distribution of training data used when creating the inspector 11B. The distribution 24C is a distribution of training data used when creating the inspector 11C. Descriptions of the training data of the star marks, triangle marks, and circle marks are similar to those of the description given in FIG. 3.

The number of pieces of training data used when creating each inspector is in the order of the inspector 11A, the inspector 11B, and the inspector 11C in descending order.

In the distribution 24A, the model application region of the first class is the model application region 25A. The model application region of the second class is the model application region 26A. The model application region of the third class is the model application region 27A.

In the distribution 24B, the model application region of the first class is a model application region 25B. The model application region of the second class is a model application region 26B. The model application region of the third class is a model application region 27B.

In the distribution 24C, the model application region of the first class is a model application region 25C. The model application region of the second class is a model application region 26C. The model application region of the third class is a model application region 27C.

As described above, in the example described in FIG. 3, each model application region is narrowed according to the number of pieces of training data, but in the example described in FIG. 4, each model application region is not narrowed regardless of the number of pieces of training data.

In the reference technique, it is difficult to adjust the model application region to an arbitrary size while intentionally specifying the classification class because it is unknown which training data has to be deleted to narrow the model application region to a certain degree. Thus, there are cases where the model application region of the inspector created by deleting the training data is not narrowed. If the model application region of the inspector is not narrowed, it will take man-hours for recreation.

For example, the reference technique has not been capable of to creating multiple inspectors that narrow the model application region of the specified classification class.

Next, processing of an information processing apparatus according to the present embodiment will be described. The information processing apparatus narrows the model application region by causing training so that, for each classification class, the training data having a low score is excluded from the data set of the same training data as the machine learning model to be monitored. In the following description, the data set of the training data will be described as “training data set”. The training data set includes a plurality of pieces of training data.

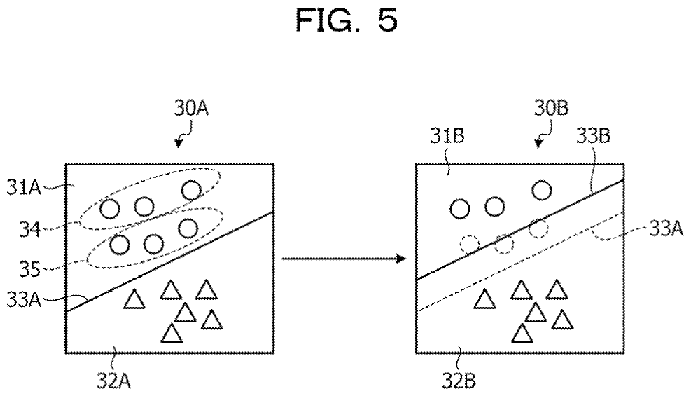

FIG. 5 is a diagram (1) for explaining processing of the information processing apparatus according to the present embodiment. In FIG. 5, for convenience of description, a case where the correct answer label (classification class) of the training data is the first class or the second class will be described. A circle mark is training data whose correct answer label is the first class. A triangle mark is training data whose correct answer label is the second class.

A distribution 30A illustrates a distribution of the training data set for creating the inspector 11A. It is assumed that the training data set for creating the inspector 11A is the same as the training data set used when training the machine learning model to be monitored. A determination boundary between the model application region 31A of the first class and the model application region 32A of the second class is defined as a determination boundary 33A.

When an existing training model (DNN) is used for the inspector 11A, the score value for each piece of training data becomes smaller as it is closer to the determination boundary of the training model. Therefore, by excluding, from the training data set, the training data having a small score among the plurality of pieces of training data, it is possible to generate an inspector that narrows the application region of the training model.

In the distribution 30A, each piece of training data contained in a region 34 has a high score because it is far from the determination boundary 33A. Each piece of training data contained in a region 35 has a low score because it is close to the determination boundary 33A. The information processing apparatus creates a new training data set in which the each piece of training data contained in the region 35 is deleted from the training data set contained in the distribution 30A.

The information processing apparatus creates the inspector 11B by training the training model with the new training data set. A distribution 30B illustrates a distribution of the training data set for creating the inspector 11B. The determination boundary between the model application region 31B of the first class and the model application region 32B of the second class is defined as a determination boundary 33B. In the new training data set, each piece of training data in the region 35 close to the determination boundary 33A is excluded, so that the position of the determination boundary 33B moves and the model application region 31B of the first class is narrower than the model application region 31A of the first class.

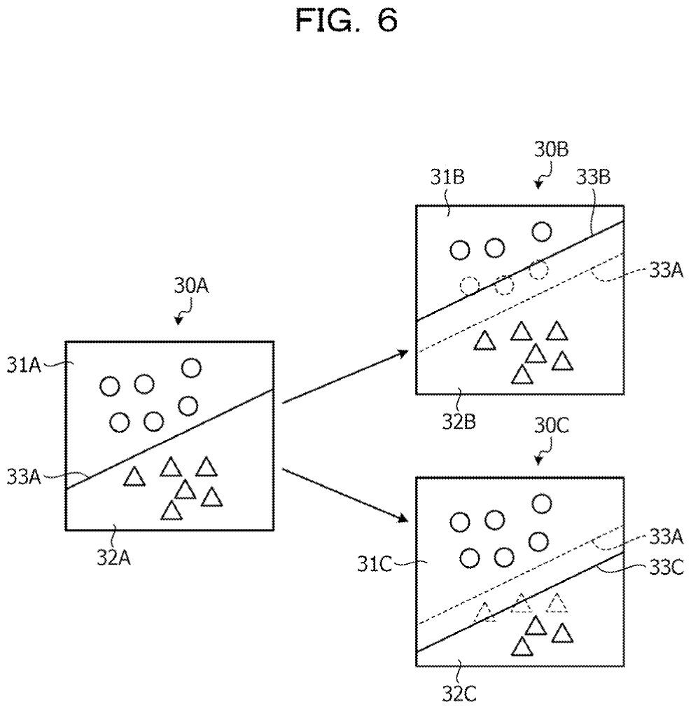

FIG. 6 is a diagram (2) for explaining the processing of the information processing apparatus according to the present embodiment. The information processing apparatus according to the present embodiment may create an inspector in which a model application range of a specific classification class is narrowed. The information processing apparatus may narrow the model application region of a specific class by designating a classification class from the training data and excluding the data having a low score.

Here, each piece of the training data is associated with a correct answer label indicating a classification class. Processing of creating the inspector 11B in which the model application region corresponding to the first class is narrowed by the information processing apparatus will be described. The information processing apparatus performs training using a first training data set excluding the training data having a low score from the training data corresponding to the correct answer label “first class”.

The distribution 30A illustrates the distribution of the training data set for creating the inspector 11A. It is assumed that the training data set for creating the inspector 11A is the same as the training data set used when training the machine learning model to be monitored. A determination boundary between the model application region 31A of the first class and the model application region 32A of the second class is defined as a determination boundary 33A.

The information processing apparatus calculates the score of the training data corresponding to the correct answer label “first class” in the training data set included in the distribution 30A, and identifies training data whose score is less than a threshold. The information processing apparatus creates a new training data set (first training data set) in which the specified training data is excluded from the training data set included in the distribution 30A.

The information processing apparatus creates the inspector 11B by training the training model using the first training data set. The distribution 30B illustrates a distribution of training data for creating the inspector 11B. The determination boundary between the model application region 31B of the first class and the model application region 32B of the second class is defined as a determination boundary 33B. Since each piece of training data close to the determination boundary 33A is excluded in the first training data set, the position of the determination boundary 33B moves, and the model application region 31B of the first class is narrower than the model application region 31A of the first class.

Next, processing of creating the inspector 11C in which the model application region corresponding to the second class is narrowed by the information processing apparatus will be described. The information processing apparatus performs training using a second training data set in which the training data having a low score is excluded from the training data corresponding to the correct answer label “second class”.

The information processing apparatus calculates the score of the training data corresponding to the correct answer label “second class” in the training data set included in the distribution 30A, and identifies training data whose score is less than a threshold. The information processing apparatus creates a new training data set (second training data set) in which the specified training data is excluded from the training data set included in the distribution 30A.

The information processing apparatus creates the inspector 11C by training the training model using the second training data set. The distribution 30C indicates a distribution of training data for creating the inspector 11C. A determination boundary between the model application region 31C of the first class and the model application region 32C of the second class is defined as a determination boundary 33C. Since each piece of training data close to the determination boundary 33A is excluded in the second training data group, the position of the determination boundary 33C moves, and the model application region 32C of the second class is narrower than the model application region 32A of the second class.

As described above, the information processing apparatus according to the present embodiment may narrow the model application region by causing training so that, for each classification class, the training data having a low score is excluded from the same training data as the machine learning model to be monitored.

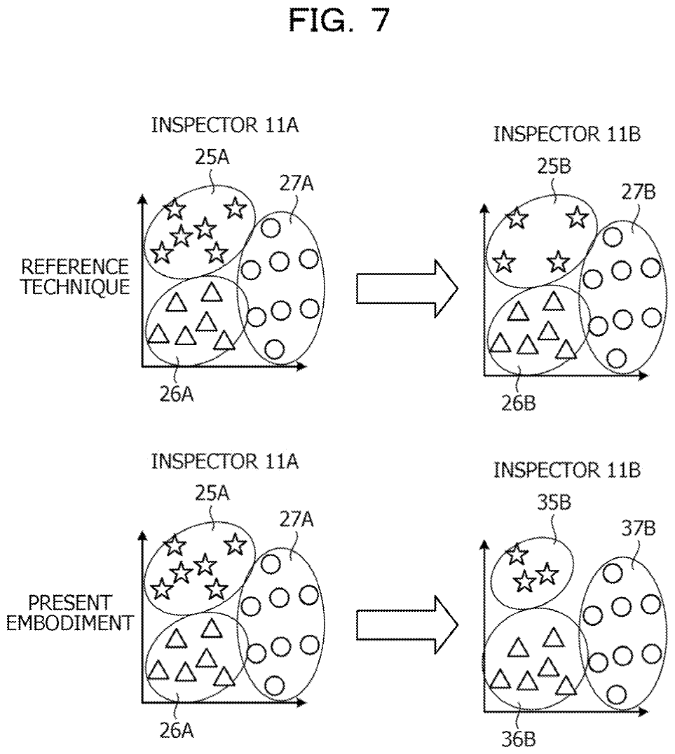

FIG. 7 is a diagram for explaining effects of the information processing apparatus according to the present embodiment. The reference technique and the information processing apparatus according to the present embodiment create the inspector 11A by training the training model using the training data set used in the training of the machine learning model 10.

In the reference technique, a new training data set is created by randomly excluding the training data from the training data set used in the training of the machine learning model 10. In the reference technique, the inspector 11B is created by training the training model using the created new training data set. In the inspector 11B of the reference technique, the model application region of the first class is the model application region 25B. The model application region of the second class is the model application region 26B. The model application region of the third class is the model application region 27B.

Here, when the model application region 25A and the model application region 25B are compared, the model application region 25B is not narrowed. Similarly, when the model application region 26A and the model application region 26B are compared, the model application region 26B is not narrowed. When the model application region 27A and the model application region 27B are compared, the model application region 27B is not narrowed.

On the other hand, the information processing apparatus according to the present embodiment creates a new training data set in which the training data having a low score is excluded from the training data set used in the training of the machine learning model 10. The information processing apparatus creates the inspector 11B by training the training model using the created new training data set. In the inspector 11B according to the present embodiment, the model application region of the first class is the model application region 35B. The model application region of the second class is the model application region 36B. The model application region of the third class is the model application region 37B.

Here, when the model application region 25A and the model application region 35B are compared, the model application region 35B is narrower.

As described above, with the information processing apparatus according to the present embodiment, by creating a new training data set in which the training data having a low score is excluded from the training data set used in the training of the machine learning model 10, the model application region of the inspector may always be narrowed. Thus, it is possible to reduce the number of steps such as recreating the inspector needed when the model application region is not narrowed.

Further, with the information processing apparatus according to the present embodiment, it is possible to create an inspector in which the model application range of a specific classification class is narrowed. By changing the class of the training data to be reduced, it is possible to always create inspectors for different model application regions, and thus it is possible to create the requirement “a plurality of inspectors for different model application regions” needed for detecting model accuracy deterioration respectively. Furthermore, by using the created inspector, it is possible to describe the cause of the detected accuracy deterioration.

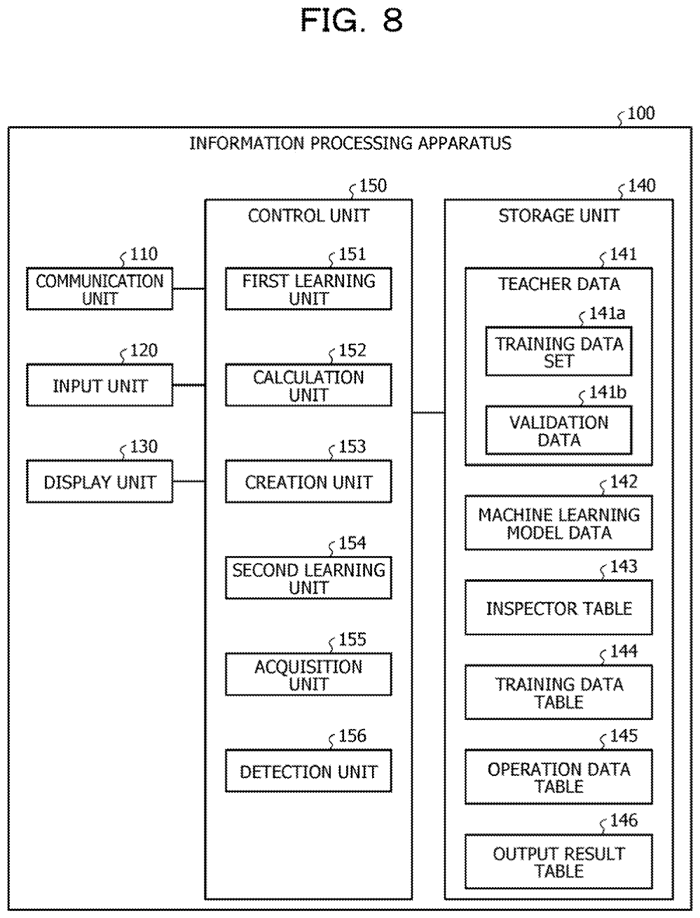

Next, one example of a configuration of the information processing apparatus according to the present embodiment will be described. FIG. 8 is a functional block diagram illustrating a configuration of the information processing apparatus according to the present embodiment. As illustrated in FIG. 8, the information processing apparatus 100 includes a communication unit 110, an input unit 120, a display unit 130, a storage unit 140, and a control unit 150.

The communication unit 110 is a processing unit that performs data communication with an external device (not illustrated) via a network. The communication unit 110 is an example of a communication device. The control unit 150 to be described later exchanges data with an external device via the communication unit 110.

The input unit 120 is an input device for inputting various types of information to the information processing apparatus 100. The input unit 120 corresponds to a keyboard, a mouse, a touch panel, or the like.

The display unit 130 is a display device that displays information output from the control unit 150. The display unit 130 corresponds to a liquid crystal display, an organic electro luminescence (EL) display, a touch panel, or the like.

The storage unit 140 has teacher data 141, machine learning model data 142, an inspector table 143, a training data table 144, an operation data table 145, and an output result table 146. The storage unit 140 corresponds to a semiconductor memory element such as a random access memory (RAM) or a flash memory, or a storage device such as a hard disk drive (HDD).

The teacher data 141 has a training data set 141a and validation data 141b. The training data set 141a holds various information about the training data.

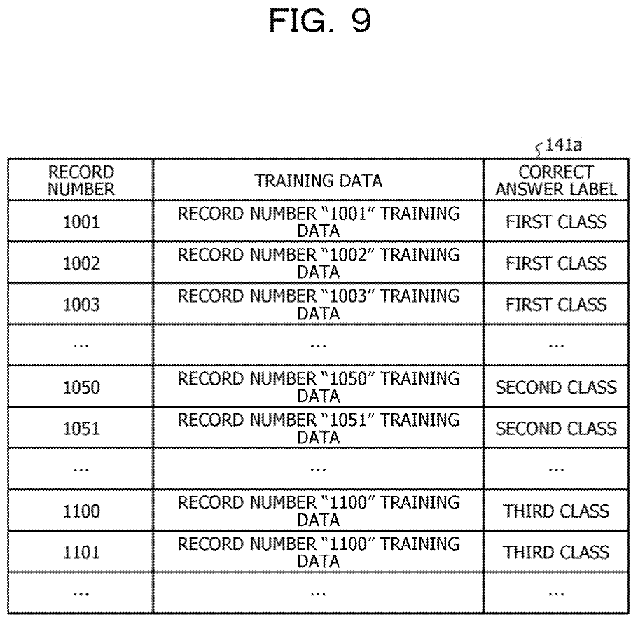

FIG. 9 is a diagram illustrating an example of the data structure of the training data set. As illustrated in FIG. 9, this training data set associates the record number with the training data and the correct answer label. The record number is a number that identifies the pair of the training data and the correct answer label. The training data corresponds to email spam data, electricity demand forecasts, stock price forecasts, poker hand data, image data, and the like. The correct answer label is information that uniquely identifies any of the respective classification classes of the first class, the second class, and the third class.

The validation data 141b is data for validating the machine learning model trained by the training data set 141a. The validation data 141b is given a correct answer label. For example, if the validation data 141b is input to the machine learning model and an output result output from the machine learning model matches the correct answer label given to validation data 141b, this means that the machine learning model has been properly trained with the training data set 141a.

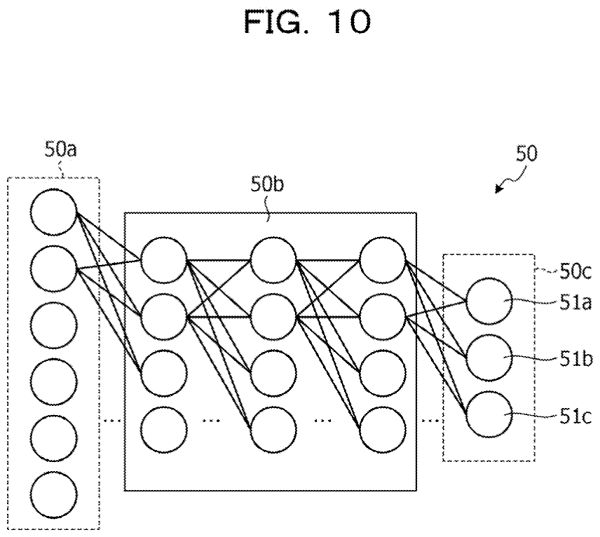

The machine learning model data 142 is data of the machine learning model. FIG. 10 is a diagram for explaining an example of a machine learning model. As illustrated in FIG. 10, the machine learning model 50 has a neural network structure, and has an input layer 50a, a hidden layer 50b, and an output layer 50c. The input layer 50a, the hidden layer 50b, and the output layer 50c have a structure in which a plurality of nodes is connected by edges. The hidden layer 50b and the output layer 50c have a function called an activation function and a bias value, and the edges have weights. In the following description, the bias value and weights will be described as “parameters”.

When data (feature amount of data) is input to each node included in the input layer 50a, the probability of each class is output from the nodes 51a, 51b, and 51c of the output layer 50c through the hidden layer 50b. For example, the node 51a outputs the probability of the first class. The probability of the second class is output from the node 51b. The probability of the third class is output from the node 51c. The probability of each class is calculated by inputting a value output from each node of the output layer 50c into the Softmax function. In the present embodiment, the value before being input to the Softmax function will be described as “score”.

For example, when the training data corresponding to the correct answer label “first class” is input to each node included in the input layer 50a, a value output from the node 51a and before inputting to the Softmax function is assumed as the score of the input training data. When the training data corresponding to the correct answer label “second class” is input to each node included in the input layer 50a, a value output from the node 51b and before inputting to the Softmax function is assumed as the score of the input training data. When the training data corresponding to the correct answer label “third class” is input to each node included in the input layer 50a, a value output from the node 51c and before inputting to the Softmax function is assumed as the score of the input training data.

It is assumed that the machine learning model 50 has been trained based on the training data set 141a and the validation data 141b of the teacher data 141. In the training of the machine learning model 50, when each piece of training data of the training data set 141a is input to the input layer 50a, parameters of the machine learning model 50 are trained (trained by an error back propagation method) so that the output result of each node of the output layer 50c approaches the correct answer label of the input training data.

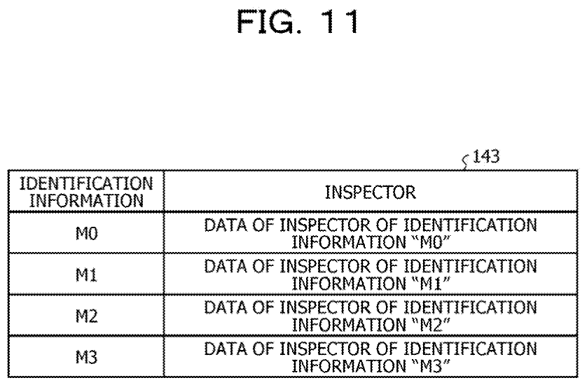

The description returns to the description of FIG. 8. The inspector table 143 is a table that holds data of a plurality of inspectors that detects the accuracy deterioration of the machine learning model 50. FIG. 11 is a diagram illustrating an example of the data structure of the inspector table. As illustrated in FIG. 11, this inspector table 143 associates identification information with an inspector. The identification information is information that identifies the inspector. The inspector is data of an inspector corresponding to the model identification information. Data of the inspector has a neural network structure similar to the machine learning model 50 described in FIG. 10, and has an input layer, a hidden layer, and an output layer. Furthermore, parameters different from each other are set for each inspector.

In the following description, an inspector of identification information “M0” will be described as “inspector M0”. An inspector of identification information “M1” will be described as “inspector M1”. An inspector of identification information “M2” will be described as “inspector M2”. An inspector of identification information “M3” will be described as “inspector M3”.

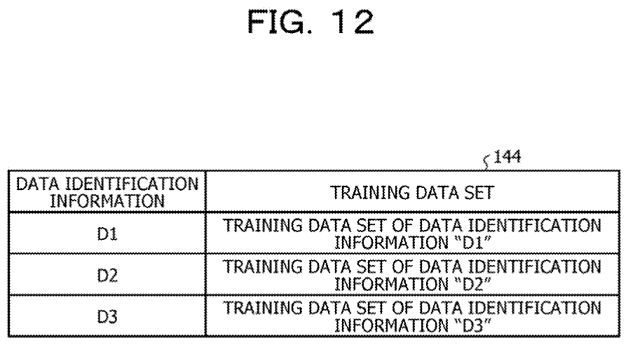

The training data table 144 has a plurality of training data sets for training each inspector. FIG. 12 is a diagram illustrating an example of the data structure of the training data table. As illustrated in FIG. 12, the training data table 144 has data identification information and a training data set. The data identification information is information that identifies a training data set. The training data set is a training data set used when training each inspector.

The training data set of the data identification information “D1” is a training data set in which the training data of the correct answer label “first class” having a low score is excluded from the training data set 141a. In the following description, the training data set of the data identification information “D1” will be described as “training data set D1”.

The training data set of the data identification information “D2” is a training data set in which the training data of the correct answer label “second class” having a low score is excluded from the training data set 141a. In the following description, the training data set of the data identification information “D2” will be described as “training data set D2”.

The training data set of the data identification information “D3” is a training data set in which the training data of the correct answer label “third class” having a low score is excluded from the training data set 141a. In the following description, the training data set of data identification information “D3” will be described as “training data set D3”.

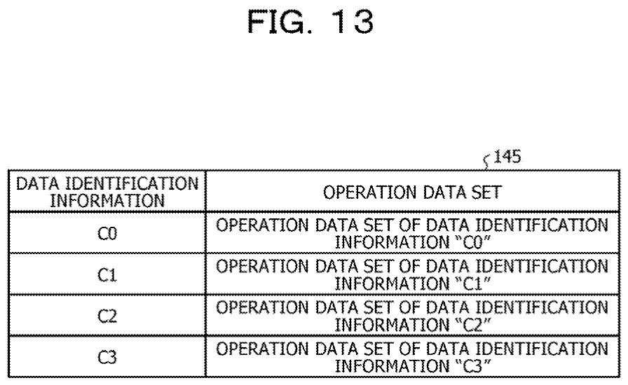

The operation data table 145 has operation data sets that are added with the passage of time. FIG. 13 is a diagram illustrating an example of the data structure of the operation data table. As illustrated in FIG. 13, the operation data table 145 has data identification information and operation data sets. The data identification information is information that identifies an operation data set. The operation data set contains a plurality of pieces of operation data. The operation data corresponds to email spam data, electricity demand forecasts, stock price forecasts, poker hand data, image data, and the like.

The operation data set of data identification information “C0” is the operation data set collected at the start of operation (t=0). In the following description, the operation data set of the data identification information “C0” will be described as “operation data set C0”.

The operation data set of data identification information “C1” is the operation data set collected after T1 hours have passed from the start of operation. In the following description, the operation data set of the data identification information “C1” will be described as “operation data set C1”.

The operation data set of data identification information “C2” is the operation data set collected after T2 (T2>T1) hours have passed from the start of operation. In the following description, the operation data set of the data identification information “C2” will be described as “operation data set C2”.

The operation data set of data identification information “C3” is the operation data set collected after T3 (T3>T2) hours have passed from the start of operation. In the following description, the operation data set of the data identification information “C3” will be described as “operation data set C3”.

Although not illustrated, it is assumed that each piece of operation data included in the operation data sets C0 to C3 is given “operation data identification information” that uniquely identifies the operation data. The operation data sets C0 to C3 are data streamed from the external device to the information processing apparatus 100, and the information processing apparatus 100 registers the operation data sets C0 to C3 which are data streamed in the operation data table 145.

The output result table 146 is a table for registering output results of the respective inspectors M0 to M3 when the respective operation data sets C0 to C3 are input to the respective inspectors M0 to M3.

The description returns to the description of FIG. 8. The control unit 150 has a first training unit 151, a calculation unit 152, a creation unit 153, a second training unit 154, an acquisition unit 155, and a detection unit 156. The control unit 150 may be implemented by a central processing unit (CPU), a micro processing unit (MPU), or the like. Furthermore, the control unit 150 may also be implemented by a hard-wired logic such as an application specific integrated circuit (ASIC) or a field programmable gate array (FPGA).

The first training unit 151 is a processing unit that creates the inspector M0 by acquiring the training data set 141a and training the parameters of the training model based on the training data set 141a. The training data set 141a is a training data set used when training the machine learning model 50. The training model has a neural network structure similar to the machine learning model 50, and has an input layer, a hidden layer, and an output layer. Furthermore, parameters (initial values of parameters) are set in the training data.

When training data of the training data set 141a is input to the input layer of the training model, the first training unit 151 updates parameters of the training model (training by the error back propagation method) so that the output result of each node of the output layer approaches the correct answer label of the input training data. The first training unit 151 registers created data of the inspector M0 in the inspector table 143.

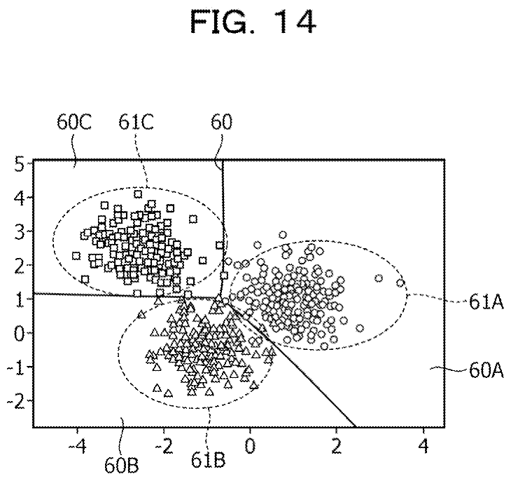

FIG. 14 is a diagram illustrating an example of the classification surface of the inspector M0. As an example, the classification surface is illustrated on two axes. The horizontal axis of the classification surface is the axis corresponding to a first feature amount of the data, and the vertical axis is the axis corresponding to a second feature amount. Note that the data may also be three-dimensional or higher. The determination boundary of the inspector M0 is a determination boundary 60. The model application region for the first class of the inspector M0 is a model application region 60A. The model application region 60A contains a plurality of pieces of training data 61A corresponding to the first class.

The model application region for the second class of the inspector M0 is a model application region 60B. The model application region 60B contains a plurality of pieces of training data 61B corresponding to the second class. The model application region for the third class of the inspector M0 is a model application region 60C. The model application region 60C contains a plurality of pieces of training data 61C corresponding to the second class.

The determination boundary 60 of the inspector M0 and the respective model application regions 60A to 60C are the same as the determination boundary of the machine learning model and the respective model application regions.

The calculation unit 152 is a processing unit that calculates each of scores of respective pieces of the training data included in the training data set 141a. The calculation unit 152 executes the inspector M0 and inputs the training data to the executed inspector M0 to thereby calculate the scores of respective pieces of training data. The calculation unit 152 outputs the scores of respective pieces of the training data to the creation unit 153.

The calculation unit 152 calculates the scores of a plurality of pieces of training data corresponding to the correct answer label “first class”. Here, among the training data of the training data set 141a, the training data corresponding to the correct answer label “first class” will be described as “first training data”. The calculation unit 152 inputs the first training data to the input layer of the inspector M0, and calculates the score of the first training data. The calculation unit 152 repeatedly executes the above processing for the plurality of pieces of first training data. The calculation unit 152 outputs calculation result data (hereinafter referred to as the first calculation result data) in which the record number of the first training data and the score are associated with each other to the creation unit 153.

The calculation unit 152 calculates the scores of a plurality of pieces of training data corresponding to the correct answer label “second class”. Here, among the training data of the training data set 141a, the training data corresponding to the correct answer label “second class” will be described as “second training data”. The calculation unit 152 inputs the second training data to the input layer of the inspector M0, and calculates the score of the second training data. The calculation unit 152 repeatedly executes the above processing for the plurality of pieces of second training data. The calculation unit 152 outputs calculation result data (hereinafter referred to as the second calculation result data) in which the record number of the second training data and the score are associated with each other to the creation unit 153.

The calculation unit 152 calculates the scores of a plurality of pieces of training data corresponding to the correct answer label “third class”. Here, among the training data of the training data set 141a, the training data corresponding to the correct answer label “third class” will be described as “third training data”. The calculation unit 152 inputs the third training data to the input layer of the inspector M0, and calculates the score of the third training data. The calculation unit 152 repeatedly executes the above processing for the plurality of pieces of third training data. The calculation unit 152 outputs calculation result data (hereinafter referred to as the third calculation result data) in which the record number of the third training data and the score are associated with each other to the creation unit 153.

The creation unit 153 is a processing unit that creates a plurality of training data sets based on the scores of respective pieces of the training data. The creation unit 153 acquires the first calculation result data, the second calculation result data, and the third calculation result data from the calculation unit 152 as data of the scores of respective pieces of the training data.

Upon acquiring the first calculation result data, the creation unit 153 identifies the first training data whose score is less than a threshold among the first training data included in the first calculation result data as the first training data to be excluded. The first training data whose score is less than the threshold is the first training data near the determination boundary 60. The creation unit 153 creates a training data set (training data set D1) in which the first training data to be excluded is excluded from the training data set 141a. The creation unit 153 registers the training data set D1 in the training data table 144.

Upon acquiring the second calculation result data, the creation unit 153 identifies the second training data whose score is less than the threshold among the second training data included in the second calculation result data as the second training data to be excluded. The second training data whose score is less than the threshold is the second training data near the determination boundary 60. The creation unit 153 creates a training data set (training data set D2) in which the second training data to be excluded is excluded from the training data set 141a. The creation unit 153 registers the training data set D2 in the training data table 144.

Upon acquiring the third calculation result data, the creation unit 153 identifies the third training data whose score is less than the threshold among the third training data included in the third calculation result data as the third training data to be excluded. The third training data whose score is less than the threshold is the third training data near the determination boundary. The creation unit 153 creates a training data set (training data set D3) in which the third training data to be excluded is excluded from the training data set 141a. The creation unit 153 registers the training data set D3 in the training data table 144.

The second training unit 154 is a processing unit that creates a plurality of inspectors M1, M2, and M3 using the training data sets D1, D2, and D3 of the training data table 144.

The second training unit 154 creates the inspector M1 by training the parameters of the training model based on the training data set D1. The training data set D1 is a data set in which the first training data near the determination boundary 60 is excluded. When training data of the training data set D1 is input to the input layer of the training model, the second training unit 154 updates the parameters of the training model (training by the error back propagation method) so that the output result of each node of the output layer approaches the correct answer label of the input training data. Thus, the second training unit 154 creates the inspector M1. The second training unit 154 registers the data of the inspector M1 in the inspector table 143.

The second training unit 154 creates the inspector M2 by training the parameters of the training model based on the training data set D2. The training data set D2 is a data set in which the second training data near the determination boundary 60 is excluded. When the training data of the training data set D2 is input to the input layer of the training model, the second training unit 154 updates the parameters of the training model (training by the error back propagation method) so that the output result of each node of the output layer approaches the correct answer label of the input training data. Thus, the second training unit 154 creates the inspector M2. The second training unit 154 registers the data of the inspector M2 in the inspector table 143.

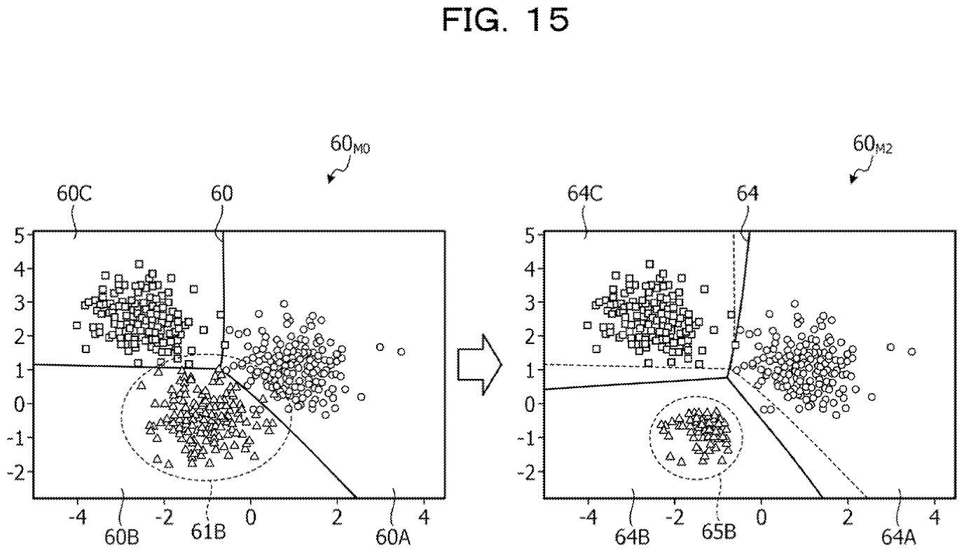

FIG. 15 is a diagram comparing classification surfaces of the inspectors M0 and M2. The classification surface of the inspector M0 is a classification surface 60_{M0}. The classification surface of the inspector M2 is a classification surface 60_{M2}. Description of the classification surface 60_{M0} of the inspector M0 is similar to the description of FIG. 14.

The determination boundary of the inspector M2 is a determination boundary 64. The model application region for the first class of the inspector M2 is a model application region 64A. The model application region for the second class of the inspector M2 is a model application region 64B. The model application region 64B contains a plurality of pieces of training data 65B corresponding to the second class and having a score equal to or higher than the threshold. The model application region for the third class of the inspector M2 is a model application region 64C.

Comparing the classification surface 60_{M0} of the inspector M0 and the classification surface 60_{M2} of the inspector M2, the model application region 64B corresponding to the model application region of the second class is narrower than the model application region 60B. This is because the second training data near the determination boundary 60 is excluded from the training data set used when training the inspector M2.

The second training unit 154 creates the inspector M3 by training the parameters of the training model based on the training data set D3. The training data set D3 is a data set in which the third training data near the determination boundary 60 is excluded. When the training data of the training data set D3 is input to the input layer of the training model, the second training unit 154 updates the parameters of the training model (training by the error back propagation method) so that the output result of each node of the output layer approaches the correct answer label of the input training data. Thus, the second training unit 154 creates the inspector M3. The second training unit 154 registers the data of the inspector M3 in the inspector table 143.

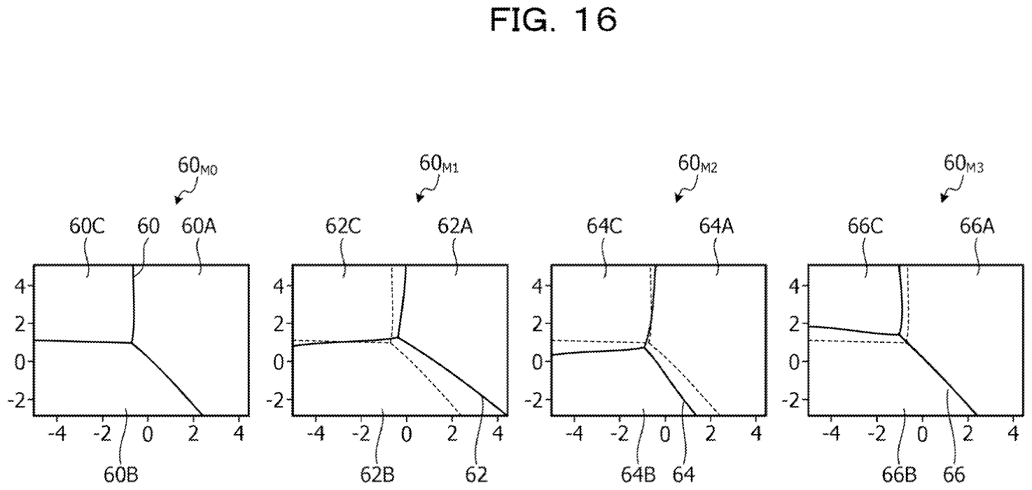

FIG. 16 is a diagram illustrating the classification surface of each inspector. The classification surface of the inspector M0 is a classification surface 60_{M0}. The classification surface of the inspector M1 is a classification surface 60_{M1}. The classification surface of the inspector M2 is a classification surface 60_{M2}. The classification surface of the inspector M3 is a classification surface 60_{M3}. Description of the classification surface 60_{M0} of the inspector M0 and the classification surface 60_{M2} of the inspector M2 is similar to the description of the description of FIG. 15.

The determination boundary of the inspector M1 is a determination boundary 62. The model application region for the first class of the inspector M1 is a model application region 62A. The model application region for the second class of the inspector M1 is a model application region 62B. The model application region for the third class of the inspector M1 is a model application region 62C.

The determination boundary of the inspector M3 is a determination boundary 66. The model application region for the first class of the inspector M3 is a model application region 66A. The model application region for the second class of the inspector M3 is a model application region 66B. The model application region for the third class of the inspector M3 is a model application region 66C.

Comparing the classification surface 60_{M0} of the inspector M0 and the classification surface 60_{M1} of the inspector M1, the model application region 62A corresponding to the model application region of the first class is narrower than the model application region 60A. This is because the first training data near the determination boundary 60 (score is less than the threshold) is excluded from the training data set used when training the inspector M1.

Comparing the classification surface 60_{M0} of the inspector M0 and the classification surface 60_{M2} of the inspector M2, the model application region 64B corresponding to the model application region of the second class is narrower than the model application region 60B. This is because the second training data near the determination boundary 60 (score is less than the threshold) is excluded from the training data set used when training the inspector M2.

Comparing the classification surface 60_{M0} of the inspector M0 and the classification surface 60_{M3} of the inspector M3, the model application region 66C corresponding to the model application region of the third class is narrower than the model application region 60C. This is because the third training data near the determination boundary 60 (score is less than the threshold) is excluded from the training data set used when training the inspector M3.

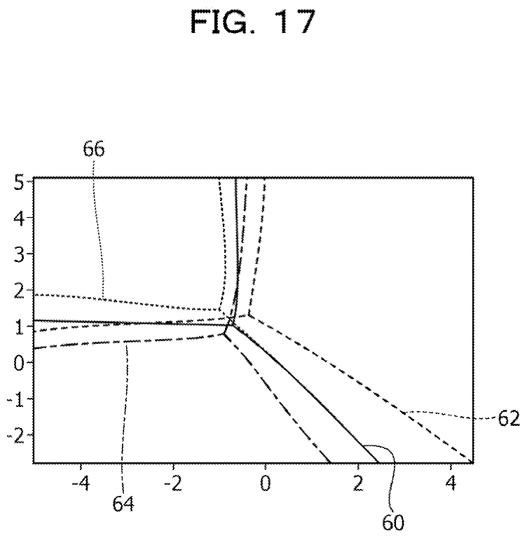

FIG. 17 is a diagram illustrating an example of a classification surface in which the classification surfaces of all the inspectors are overlapped. As illustrated in FIG. 17, the determination boundaries 60, 62, 65, and 66 are each different, and also the model application regions of the first, second, and third classes are each different.

The description returns to the description of FIG. 8. The acquisition unit 155 is a processing unit that inputs operation data whose feature amount changes with the passage of time to each of a plurality of inspectors and acquires an output result.

For example, the acquisition unit 155 acquires the data of the inspectors M0 to M2 from the inspector table 143 and executes the inspectors M0 to M2. The acquisition unit 155 inputs the respective operation data sets C0 to C3 stored in the operation data table 145 to the inspectors M0 to M2, acquires respective output results, and registers the output results in the output result table 146.

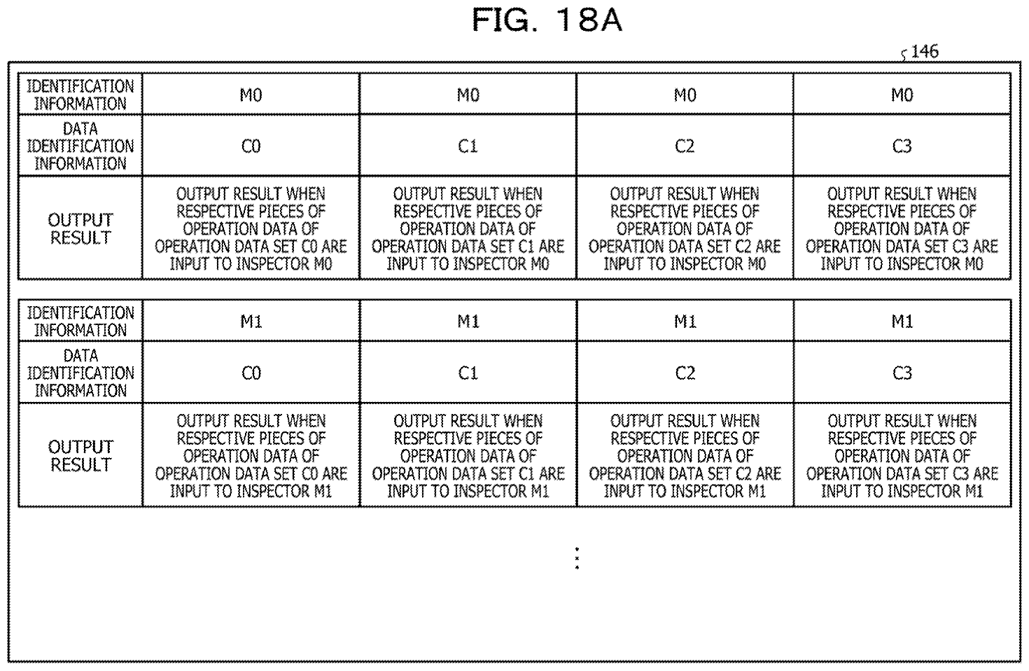

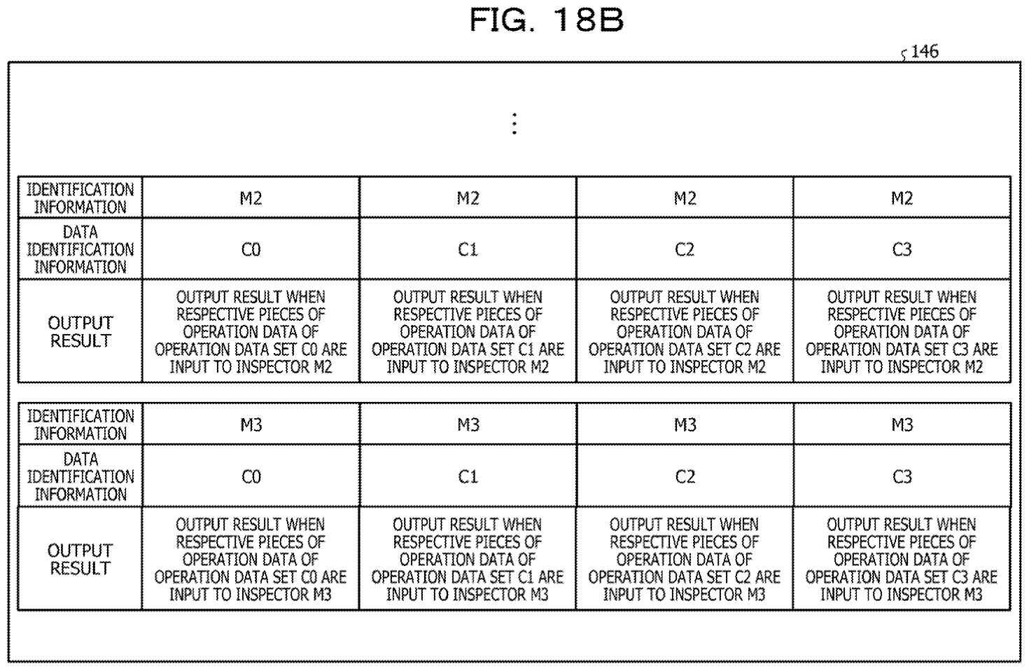

FIG. 18A and FIG. 18B are diagrams illustrating an example of the data structure of the output result table. As illustrated in FIG. 18A and FIG. 18B, in the output result table 146, the identification information that identifies the inspector, the data identification information that identifies the input operation data set, and the output result are associated with each other. For example, the output result corresponding to the identification information “M0” and the data identification information “C0” is the output result when respective pieces of operation data of the operation data set C0 are input to the inspector M0.

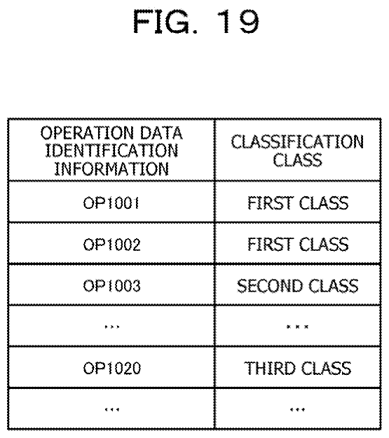

FIG. 19 is a diagram illustrating an example of the data structure of the output results of the output result table. The example illustrated in FIG. 19 corresponds to any one of the output results among the respective output results included in the output result table 146. The operation data identification information and the classification class are associated with the output result. The operation data identification information is information that uniquely identifies the operation data. The classification class is information that uniquely identifies the classification class in which the operation data is classified. For example, it is illustrated that the output result (classification class) when the operation data of the operation data identification information “OP1001” is input to the corresponding inspector is the first class.

The description returns to the description of FIG. 8. The detection unit 156 is a processing unit that detects data that is a factor of the output result of the machine learning model 50 based on the time change of the data, based on the output result table 146.

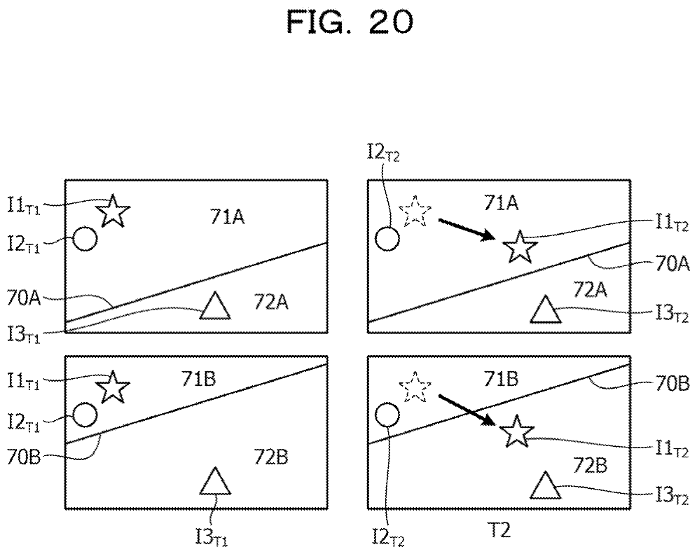

FIG. 20 is a diagram for explaining the processing of the detection unit. Here, as an example, the inspectors M0 and M1 will be used for description. For convenience, the determination boundary of the inspector M0 is the determination boundary 70A, and the determination boundary of inspector M1 is the determination boundary 70B. The positions of the determination boundary 70A and the determination boundary 70B are different from each other, and the model application region is different. In the following description, one piece of operation data included in the operation data set will be appropriately described as an “instance”.

When the instance is located in the model application region 71A, the instance is classified by the inspector M0 into the first class. When the instance is located in the model application region 72A, the instance is classified by the inspector M0 into the second class.

When the instance is located in model application region 71B, the instance is classified by the inspector M1 into the first class. When the instance is located in model application region 72B, the instance is classified by the inspector M1 into the second class.

For example, if an instance I1_{T1} is input to the inspector M0 at the time T1 in the initial stage of operation, the instance I1_{T1} is located in the model application region 71A and is therefore classified as the “first class”. If an instance I2_{T1} is input to the inspector M0, the instance I2_{T1} is located in the model application region 71A and is therefore classified as the “first class”. If an instance I3_{T1} is input to the inspector M0, the instance I3_{T1} is located in the model application region 72A and is therefore classified as the “second class”.

If the instance I1_{T1} is input to the inspector M1 at the time T1 in the initial stage of operation, the instance I1_{T1} is located in the model application region 71B and is therefore classified as the “first class”. If the instance I2_{T1} is input to the inspector M1, the instance I2_{T1} is located in the model application region 71B and is therefore classified as the “first class”. If the instance I3_{T1} is input to the inspector M1, the instance I3_{T1} is located in the model application region 72B and is therefore classified as the “second class”.

The classification results classified when the instances I1_{T1}, I2_{T1}, and I3_{T1} are input to the inspectors M0 and M1 are the same to each other at the time T1 in the initial stage of operation, and thus the detection unit 156 does not detect the accuracy deterioration of the machine learning model 50.

Incidentally, at the time T2 when time has passed since the initial stage of operation, the tendency of the instance changes, and the instances I1_{T1}, I2_{T1}, and I3_{T1} become instances I1_{T2}, I2_{T2}, and I3_{T2}. If the instance I1_{T2} is input to the inspector M0, the instance I1_{T2} is located in the model application region 71A and is therefore classified as the “first class”. If the instance I2_{T2} is input to the inspector M0, the instance I2_{T1} is located in the model application region 71A and is therefore classified as the “first class”. If the instance I3_{T2} is input in inspector M0, the instance I3_{T2} is located in the model application region 72A and is therefore classified as the “second class”.

If the instance I1_{T2} is input to the inspector M1 at the time T2 when time has passed since the initial stage of operation, the instance I1_{T2} is located in the model application region 72B and is therefore classified as the “second class”. If the instance I2_{T2} is input to the inspector M1, the instance I2_{T2} is located in the model application region 71B and is therefore classified as the “first class”. If the instance I3_{T2} is input to the inspector M1, the instance I3_{T2} is located in the model application region 72B and is therefore classified as the “second class”.

The classification results classified when the instance I1_{T1} is input to the inspectors M0 and M1 are different from each other at the time T2 when time has passed since the initial stage of operation, and thus the detection unit 156 detects the accuracy deterioration of the machine learning model 50. Furthermore, the detection unit 156 may detect the instance I1_{T2} that has been a factor of the accuracy deterioration.

The detection unit 156 refers to the output result table 146, specifies the classification class when input to each inspector for each instance (operation data) of each operation data set, and repeatedly executes the above processing.

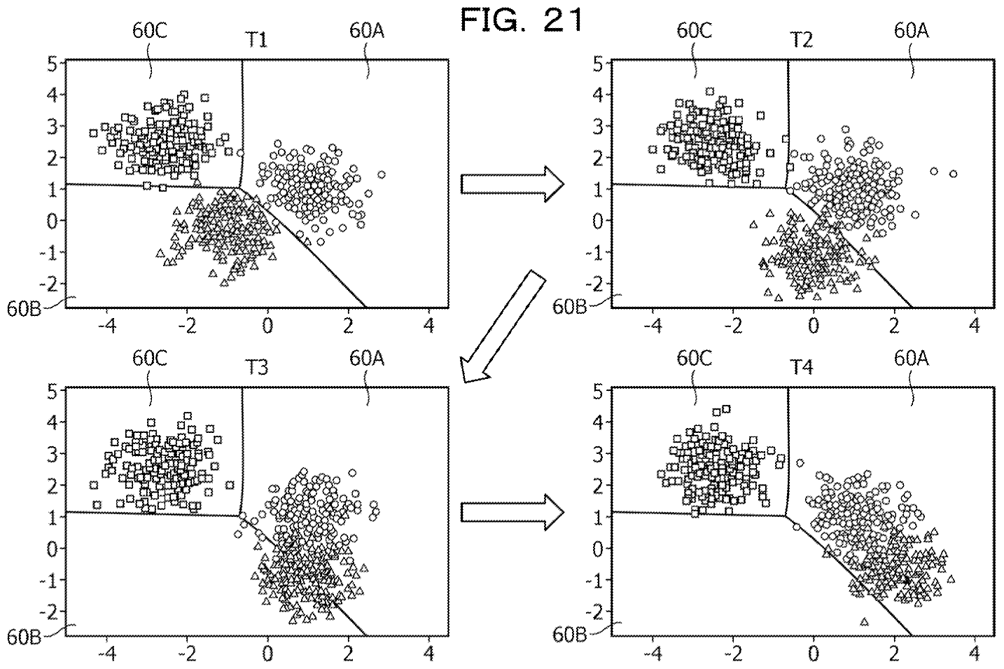

FIG. 21 is a diagram illustrating changes in the operation data set with passage of time. FIG. 21 illustrates the distribution when each operation data set is input to the inspector M0. In FIG. 21, it is correct that each piece of the operation data with a circle mark is originally data belonging to the first class and is classified into the model application region 60A. It is correct that each piece of the operation data with a triangle mark is originally data belonging to the second class and is classified in the model application region 60B. It is correct that each piece of the operation data with a square mark is originally data belonging to the third class and is classified in the model application region 60C.

In the operation data set C0 at the time T1 in the initial stage of operation, each piece of the operation data with a circle mark is included in the model application region 60A. Each piece of the operation data with a triangle mark is included in the model application region 60B. Each piece of the operation data with a square mark is included in the model application region 60C. For example, each piece of the operation data is appropriately classified into a classification class, and the accuracy deterioration is not detected.

In the operation data set C1 where T2 hours have passed from the initial stage of operation, each piece of the operation data with a circle mark is included in the model application region 60A. Each piece of the operation data with a triangle mark is included in the model application region 60B. Each piece of the operation data with a square mark is included in the model application region 60C. Although the center of respective pieces of the operation data with a triangle mark has moved (drifted) to the model application region 60A side, most of the operation data is properly classified into the classification class, and the accuracy deterioration is not detected.

In the operation data set C2 where T3 hours have passed from the initial stage of operation, each piece of the operation data with a circle mark is included in the model application region 60A. Each piece of the operation data with a triangle mark is included in the model application regions 60A and 60B. Each piece of the operation data with a square mark is included in the model application region 60C. Approximately half of the respective pieces of the operation data with a triangle mark have moved (drifted) to the model application region 60A across the determination boundary, and the accuracy deterioration is detected.

In the operation data set C3 where T4 hours have passed from the initial stage of operation, each piece of the operation data with a circle mark is included in the model application region 60A. Each piece of the operation data with a triangle mark is included in the model application region 60A. Each piece of the operation data with a square mark is included in the model application region 60C. The respective pieces of the operation data with a triangle mark have moved (drifted) to the model application region 60A across the determination boundary, and the accuracy deterioration is detected.

Although not illustrated, the detection unit 156 executes the following processing to detect, for each instance, whether or not the instance is caused by the accuracy deterioration and which direction of the classification class the feature amount of the instance has moved to. The detection unit 156 refers to the output result table 146 and identifies the classification class when the same instance is input to each inspector M0 to M3. The same instance is operation data to which the same operation data identification information is assigned.

In a case where all the classification classes (output results) when the same instance is input to each inspector M0 to M3 are the same, the detection unit 156 determines that the corresponding instance is not caused by the accuracy deterioration. On the other hand, in a case where all the classification classes when the same instance is input to each inspector M0 to M3 are not the same, the detection unit 156 detects the corresponding instance as an instance caused by the accuracy deterioration.

In a case where the output result when the instance caused by the accuracy deterioration is input to the inspector M0 and the output result when the instance is input to the inspector M1 are different, the detection unit 156 detects that the feature amount of the instance has changed to “the direction of the first class”.

In a case where the output result when the instance caused by the accuracy deterioration is input to the inspector M0 and the output result when the instance is input to the inspector M2 are different, the detection unit 156 detects that the feature amount of the instance has changed to “the direction of the second class”.

In a case where the output result when the instance caused by the accuracy deterioration is input to the inspector M0 and the output result when the instance is input to the inspector M3 are different, the detection unit 156 detects that the feature amount of the instance has changed to “the direction of the third class”.

By repeatedly executing the above processing for each instance, the detection unit 156 detects, for each instance, whether or not the instance is caused by the accuracy deterioration and which direction of the classification class the feature amount of the instance has moved to.

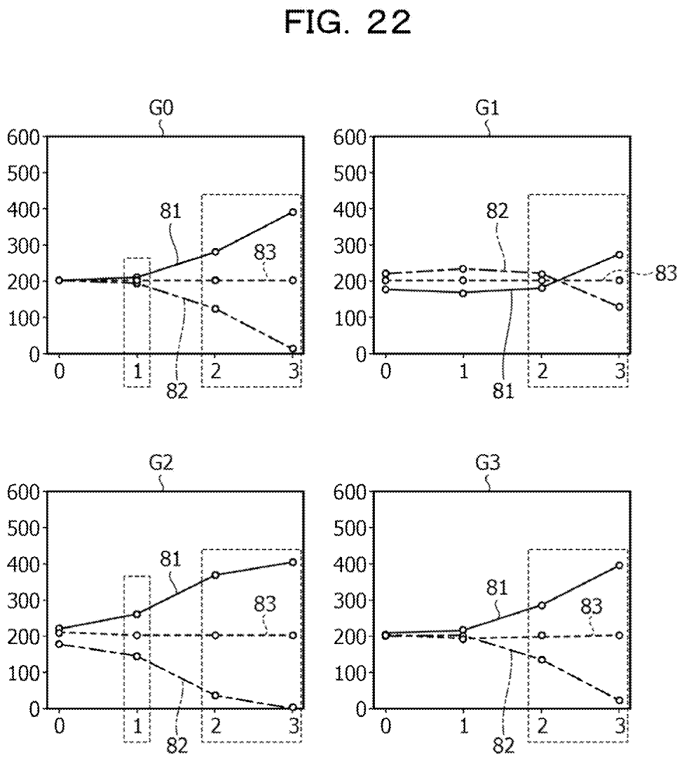

Incidentally, the detection unit 156 may also generate a graph of changes in the classification class with time changes of the operation data included in each model application region of each inspector based on the output result table 146. For example, the detection unit 156 generates the information of the graphs G0 to G3 as illustrated in FIG. 22. The detection unit 156 may also cause the information of the graphs G0 to G3 to be displayed on the display unit 130.

FIG. 22 is a diagram (2) for explaining the processing of the detection unit. In FIG. 22, the graph G0 is a graph indicating changes in the number of pieces of operation data located in each class application region when each operation data set is input to the inspector M0. The graph G1 is a graph indicating changes in the number of pieces of operation data located in each class application region when each operation data set is input to the inspector M1. The graph G2 is a graph indicating changes in the number of pieces of operation data located in each class application region when each operation data set is input to the inspector M2. The graph G3 is a graph indicating changes in the number of pieces of operation data located in each class application region when each operation data set is input to the inspector M3.

The horizontal axis of the graphs G0, G1, G2, and G3 is an axis representing the passage of time in the operation data set. The vertical axis of the graphs G0, G1, G2, and G3 is an axis representing the number of pieces of operation data included in respective pieces of model region data. A line 81 of each graph G0, G1, G2, or G3 represents a transition of the number of pieces of operation data included in the model application region of the first class. A line 82 of each graph G0, G1, G2, or G3 represents a transition of the number of pieces of operation data included in the model application region of the second class. A line 83 of each graph G0, G1, G2, or G3 represents a transition of the number of pieces of operation data included in the model application region of the third class.

The detection unit 156 detects a sign of accuracy deterioration of the machine learning model 50 by comparing the graph G0 corresponding to the inspector M0 with the graphs G1, G2, and G3 corresponding to the another inspectors M1, M2, and M3. Furthermore, the detection unit 156 may identify the cause of the accuracy deterioration.

At time t=1 in FIG. 22, the number of pieces of operation data included in respective pieces of model region data of the graph G0 and the number of pieces of operation data included in respective pieces of model region data of the graph G1 are different, so that the detection unit 156 detects the accuracy deterioration (the sign of the accuracy deterioration) of the machine learning model 50.

The detection unit 156 detects the cause of the accuracy deterioration based on the change in the number of pieces of operation data included in respective pieces of model region data of the graphs G0 to G3 at the time t=2 to 3 in FIG. 22. The line 83 of the graphs G0 to G3 has not changed, and thus the detection unit 156 excludes each piece of operation data classified into the third class corresponding to the line 83 from the target of the cause of the accuracy deterioration.

The detection unit 156 detects that, at time t=2 to 3, the line 81 of the graphs G0 to G3 increases and the line 82 decreases, and each piece of operation data classified into the second class moves to the class application region of the first class.

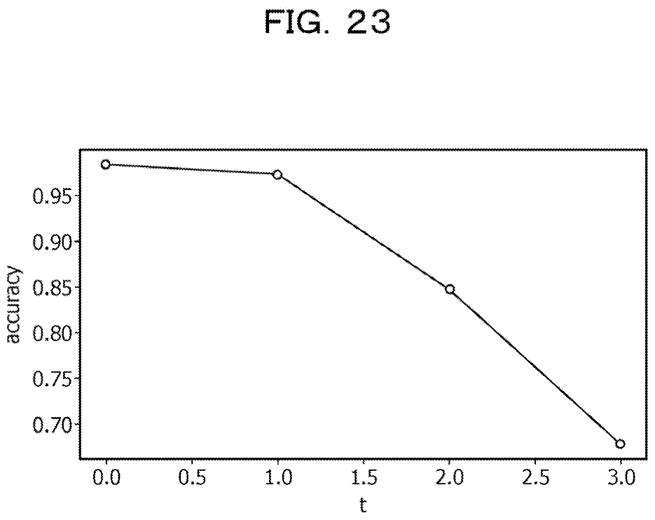

The detection unit 156 generates a graph of accuracy deterioration information based on the above detection result. FIG. 23 is a diagram illustrating an example of the graph of the accuracy deterioration information. The horizontal axis of the graph in FIG. 23 is an axis representing the passage of time in the operation data set. The vertical axis of the graph is an axis representing accuracy. In the example illustrated in FIG. 23, the accuracy decreases after the time t=1.

The detection unit 156 calculates, as accuracy, the degree of matching between the output results of the inspector M0 and the output results of the another inspectors M1 to M3 among the instances included in the operation data set. The detection unit 156 may also calculate the accuracy by using another conventional technique. The detection unit 156 may also cause a graph of information deterioration information to be displayed on the display unit 130.

Incidentally, the detection unit 156 may also output a request for re-training of the machine learning model 50 to the first training unit 151 when the accuracy becomes less than the threshold. For example, the detection unit 156 selects the latest operation data set from respective operation data sets included in the operation data table 145. The detection unit 156 inputs each piece of operation data of the selected operation data set to the inspector M0, specifies the output result, and sets the specified output result as the correct answer label of the operation data. The detection unit 156 repeatedly executes the above processing for each piece of operation data to generate a new training data set.

The detection unit 156 outputs the new training data set to the first training unit 151. The first training unit 151 uses the new training data set to execute re-training to update the parameters of the machine learning model 50. When the training data of the new training data set is input to the input layer of the machine learning model 50, the first training unit 151 updates the parameters of the machine learning model (training by the error back propagation method) so that the output result of each node of the output layer approaches the correct answer label of the input training data.

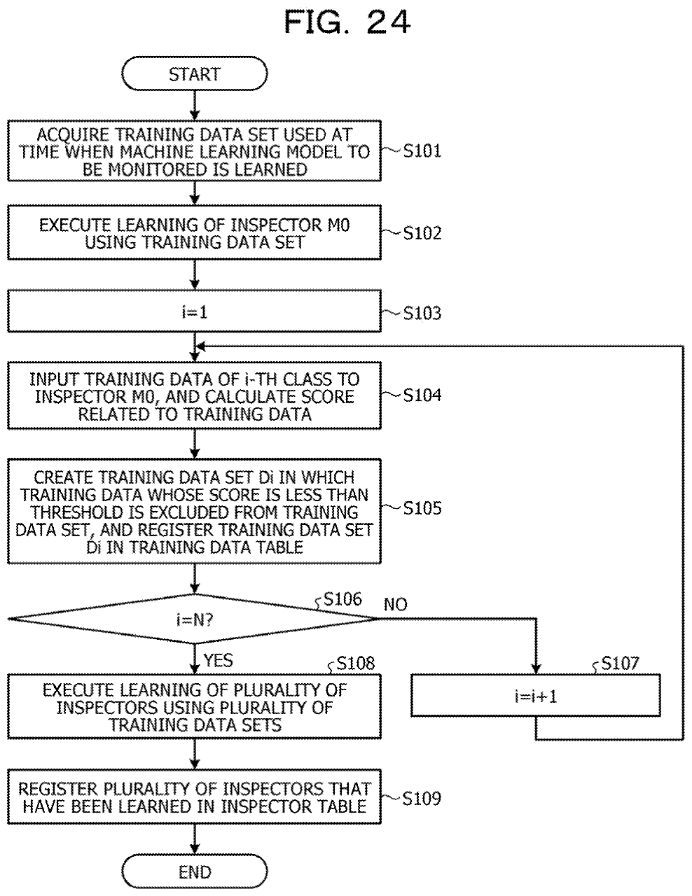

Next, an example of a processing procedure of the information processing apparatus 100 according to the present embodiment will be described. FIG. 24 is a flowchart (1) illustrating a processing procedure of the information processing apparatus according to the present embodiment. As illustrated in FIG. 24, the first training unit 151 of the information processing apparatus 100 acquires the training data set 141a used for training of the machine learning model to be monitored (step S101).

The first training unit 151 executes training of the inspector M0 using the training data set 141a (step S102). The information processing apparatus 100 sets the value of i to 1 (step S103).

The calculation unit 152 of the information processing apparatus 100 inputs the training data of the i-th class to the inspector M0, and calculates the score related to the training data (step S104). The creation unit 153 of the information processing apparatus 100 creates a training data set Di in which the training data whose score is less than the threshold is excluded from the training data set 141a, and registers the training data set Di in the training data table 144 (step S105).

The information processing apparatus 100 determines whether or not the value of i is N (for example, N=3) (step S106). In a case where the value of i is N (step S106, Yes), the information processing apparatus proceeds to step S108. On the other hand, in a case where the value of i is not N (step S106, No), the information processing apparatus 100 proceeds to step S107. The information processing apparatus 100 updates the value of i by a value obtained by adding one to the value of i (step S107), and proceeds to step S104.

The second training unit 154 of the information processing apparatus 100 executes training of the plurality of inspectors M1 to M3 using a plurality of training data sets D1 to D3 (step S108). The second training unit 154 registers the plurality of trained inspectors M1 to M3 in the inspector table 143 (step S109).

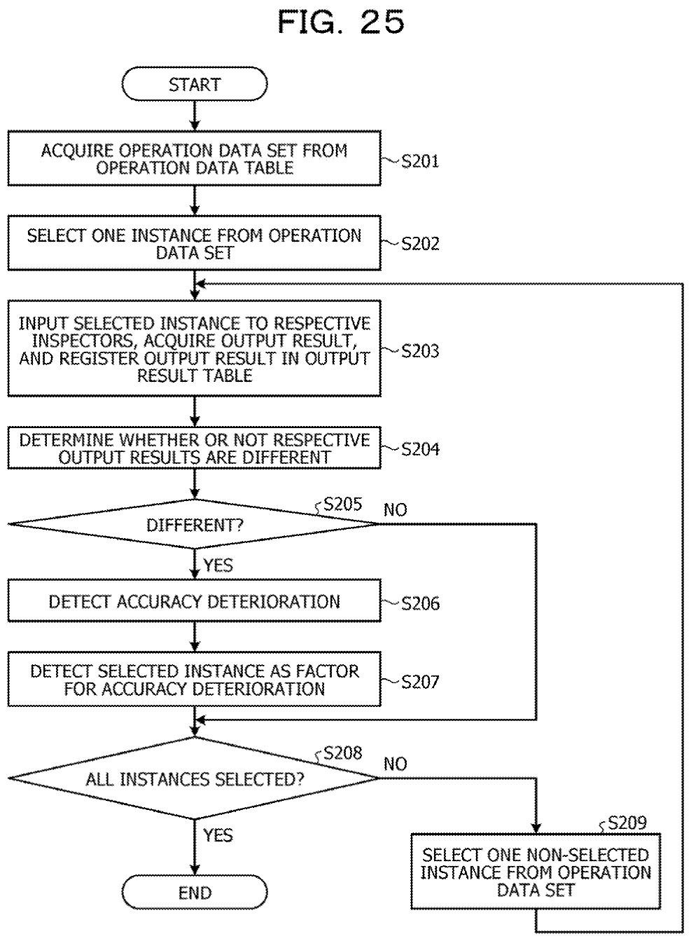

FIG. 25 is a flowchart (2) illustrating a processing procedure of the information processing apparatus according to the present embodiment. The acquisition unit 155 of the information processing apparatus 100 acquires an operation data set from the operation data table 145 (step S201). The acquisition unit 155 selects one instance from the operation data set (step S202).

The acquisition unit 155 inputs the selected instance to each inspector M0 to M3, acquires an output result, and registers the output result in the output result table 146 (step S203). The detection unit 156 of the information processing apparatus 100 refers to the output result table 146 and determines whether or not respective output results are different (step S204).

When the respective output results are not different (steps S205, No), the detection unit 156 proceeds to step S208. When the respective output results are different (step S205, Yes), the detection unit 156 proceeds to step S206.

The detection unit 156 detects the accuracy deterioration (step S206). The detection unit 156 detects a selected instance as a factor of the accuracy deterioration (step S207). The information processing apparatus 100 determines whether or not all the instances have been selected (step S208).

When all the instances have been selected (step S208, Yes), the information processing apparatus 100 ends the process. On the other hand, when all the instances have not been selected (step S208, No), the information processing apparatus 100 proceeds to step S209. The acquisition unit 15 selects one unselected instance from the operation data set (step S209), and proceeds to step S203.

The information processing apparatus 100 executes the process described with reference to FIG. 25 for each operation data set stored in the operation data table 145.

Next, effects of the information processing apparatus 100 according to the present embodiment will be described. The information processing apparatus 100 creates a new training data set in which the training data having a low score is excluded from the training data set 141a used in the training of the machine learning model 50, and creates the inspectors M1 to M3 by using the new training data, so that the model application regions of the inspectors may always be narrowed. Thus, it is possible to reduce the number of steps such as recreating the inspector needed when the model application region is not narrowed.

Furthermore, with the information processing apparatus 100, it is possible to create the inspectors M1 to M3 in which the model application ranges of specific classification classes are narrowed. By changing the class of the training data to be reduced, it is possible to always create inspectors for different model application regions, and thus it is possible to create the requirement “a plurality of inspectors for different model application regions” needed for detecting model accuracy deterioration respectively. Furthermore, by using the created inspector, it is possible to describe the cause of the detected accuracy deterioration.

The information processing apparatus 100 inputs the operation data (instance) of the operation data set to the inspectors M0 to M3, acquires respective output results of the respective inspectors M0 to M3, and detects the accuracy deterioration of the machine learning model 50 based on the respective output results. Thus, it is possible to detect the accuracy deterioration of the machine learning model 50 and also detect the instance that has been a factor of the accuracy deterioration. In the present embodiment, the case where the inspectors M1 to M3 are created has been described, but other inspectors may be also created additionally to detect the accuracy deterioration.

Upon detecting the accuracy deterioration of the machine learning model 50, the information processing apparatus 100 creates a new training data set in which a classification class (correct answer label) corresponding to the operation data of the operation data set is set, and executes re-training of the machine learning model 50 by using the created training data set. Thus, even if the feature amount of the operation data set changes with passage of time, it is possible to train a machine learning model corresponding to the change and respond to the change in the feature amount.

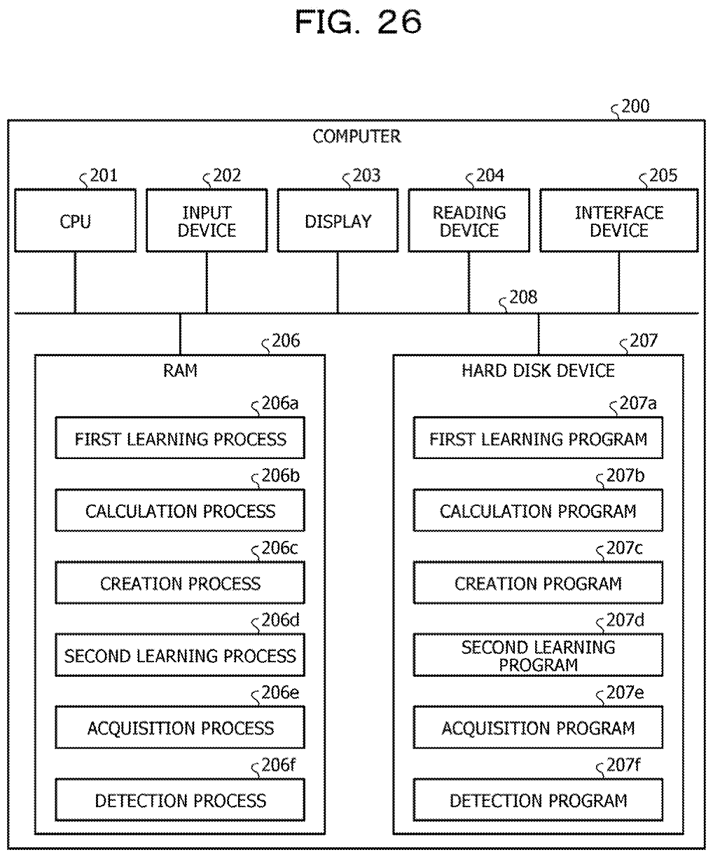

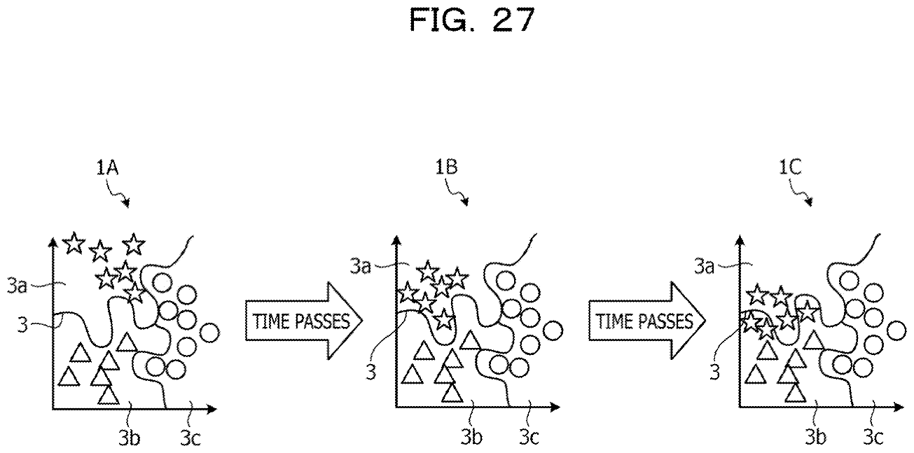

Next, one example of a hardware configuration of a computer that implements functions similar to those of the information processing apparatus 100 described in the present embodiment will be described. FIG. 26 is a diagram illustrating an example of a hardware configuration of a computer that implements functions similar to those of the information processing apparatus according to the present embodiment.

As illustrated in FIG. 26, a computer 200 includes a CPU 201 that executes various types of calculation processing, an input device 202 that receives input of data from a user, and a display 203. Furthermore, the computer 200 includes a reading device 204 that reads a program and the like from a storage medium, and an interface device 205 that exchanges data with an external device or the like via a wired or wireless network. The computer 200 includes a RAM 206 that temporarily stores various types of information, and a hard disk device 207. Then, each of the devices 201 to 207 is connected to a bus 208.

The hard disk device 207 includes a first training program 207a, a calculation program 207b, a creation program 207c, a second training program 207d, an acquisition program 207e, and a detection program 207f. The CPU 201 reads the first training program 207a, the calculation program 207b, the creation program 207c, the second training program 207d, the acquisition program 207e, and the detection program 207f and develops the programs in the RAM 206.

The first training program 207a functions as a first training process 206a. The calculation program 207b functions as a calculation process 206b. The creation program 207c functions as a creation process 206c. The second training program 207d functions as a second training process 206d. The acquisition program 207e functions as an acquisition process 206e. The detection program 207f functions as a detection process 206f.

Processing of the first training process 206a corresponds to the processing of the first training unit 151. Processing of the calculation process 206b corresponds to the processing of the calculation unit 152. Processing of the creation process 206c corresponds to the processing of the creation unit 153. Processing of the second training process 206d corresponds to the processing of the second training unit 154. Processing of the acquisition process 206e corresponds to the processing of the acquisition unit 155. Processing of the detection process 206f corresponds to the processing of the detection unit 156.

Note that each of the programs 207a to 207f is not necessarily stored in the hard disk device 507 beforehand. For example, each of the programs is stored in a “portable physical medium” such as a flexible disk (FD), a compact disc read only memory (CD-ROM), a digital versatile disc (DVD) disk, a magneto-optical disk, or an integrated circuit (IC) card to be inserted in the computer 200. Then, the computer 200 may also read and execute each of the programs 207a to 207f.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A creation method for a computer to execute a process comprising:
training a first detection model by using a first training data set;
acquiring each of scores of a plurality of pieces of training data included in the first training data set by using the first detection model;
creating a second training data set by excluding a part of the training data from the first training data set based on the scores; and
training a second detection model by using the second training data set.

2. The creation method according to claim 1, wherein
the plurality of pieces of training data included in the first training data set is associated with a label that identifies a class, wherein
the creating includes creating the second training data set by excluding a part of the training data from the first training data set based on the scores of the plurality of pieces of training data that corresponds to an identical class.

3. The creation method according to claim 2, wherein
the creating includes creating a plurality of second training data sets based on the scores of the plurality of pieces of training data for each class, and
the training the second detection model includes training a plurality of second detection models based on the plurality of second training data sets.

4. A non-transitory computer-readable storage medium storing a creation program that causes at least one computer to execute a process, the process comprising:
training a first detection model by using a first training data set;
acquiring each of scores of a plurality of pieces of training data included in the first training data set by using the first detection model;
creating a second training data set by excluding a part of the training data from the first training data set based on the scores; and
training a second detection model by using the second training data set.

5. The non-transitory computer-readable storage medium according to claim 4, wherein
the plurality of pieces of training data included in the first training data set is associated with a label that identifies a class, wherein
the creating includes creating the second training data set by excluding a part of the training data from the first training data set based on the scores of the plurality of pieces of training data that corresponds to an identical class.

6. The non-transitory computer-readable storage medium according to claim 5, wherein
the creating includes creating a plurality of second training data sets based on the scores of the plurality of pieces of training data for each class, and
the training the second detection model includes training a plurality of second detection models based on the plurality of second training data sets.

7. An information processing apparatus comprising:
one or more memories; and
one or more processors coupled to the one or more memories and the one or more processors configured to:
train a first detection model by using a first training data set,
acquire each of scores of a plurality of pieces of training data included in the first training data set by using the first detection model,
create a second training data set by excluding a part of the training data from the first training data set based on the scores, and
train a second detection model by using the second training data set.

8. The information processing apparatus according to claim 7, wherein
the plurality of pieces of training data included in the first training data set is associated with a label that identifies a class, wherein
the one or more processors are further configured to create the second training data set by excluding a part of the training data from the first training data set based on the scores of the plurality of pieces of training data that corresponds to an identical class.

9. The information processing apparatus according to claim 8, wherein the one or more processors are further configured to:
create a plurality of second training data sets based on the scores of the plurality of pieces of training data for each class, and
train a plurality of second detection models based on the plurality of second training data sets.
